(19) United States
(12) Patent Application Publication
(10) Pub. No.: US 2007/0174783 A1
(43) Pub. Date: Jul. 26, 2007

(54) System and method of intelligent window placement for digital video

(76) Inventors: Timothy P. Clark, Rochester, MN (US); Zachary A. Garbow, Rochester, MN (US); Richard M. Theis, Rochester, MN (US); Brian P. Wallenfelt, Rochester, MN (US)

Correspondence Address: IBM CORPORATION, 3605 HIGHWAY 52 NORTH, DEPT 917, ROCHESTER, MN, 55901-7829, US

(21) Appl. No.: 11/341,579

(22) Filed: Jan. 26, 2006

(51) Int. Cl. G06F 3/048; H04N 5/44

(52) U.S. Cl. 715/788; 715/719

(57) ABSTRACT

A method, apparatus, and computer-usable medium for displaying a primary presentation on a display, where the primary presentation includes a collection of frames; in response to receiving a request to overlay the primary presentation with a secondary presentation, analyzing the plurality of frames to identify at least one safe region determined to be suitable for overlaying said primary presentation with a secondary presentation; presenting a preview of the secondary presentation in at least one safe region; in response to receiving a rejection of the preview, indicating a collection of alternate safe regions for presenting the secondary presentation; and in response to an alternate safe region among the collection of alternate safe regions being selected, displaying the secondary presentation in the selected alternate safe region.

### BACKGROUND OF THE INVENTION

1. Technical Field

The present invention relates in general to the field of data processing systems. More specifically, the present invention relates to a system and method for intelligent window placement for digital video.

2. Description of the Related Art

Video displays such as televisions and computer monitors often present information from more than one source. This is true with multiple windows on a computer screen, and trends indicate that televisions will soon allow viewing information originating from distinct sources. While the primary purpose of the screen is to display full screen video content, there is a need to present visual information from a secondary source in a way which minimizes interference between the primary video content and the secondary information.

Therefore, there is a need for a system and method to identify and utilize the parts of a video screen which would least likely interrupt the primary content on the video display.

### SUMMARY OF THE INVENTION

The present invention includes, but is not limited to, a method, apparatus, and computer-usable medium for displaying a primary presentation on a display, where the primary presentation includes a collection of frames; in response to receiving a request to overlay the primary presentation with a secondary presentation, analyzing the plurality of frames to identify at least one safe region determined to be suitable for overlaying said primary presentation with a secondary presentation; presenting a preview of the secondary presentation in at least one safe region; in response to receiving a rejection of the preview, indicating a collection of alternate safe regions for presenting the secondary presentation; and in response to an alternate safe region among the collection of alternate safe regions being selected, displaying the secondary presentation in the selected alternate safe region.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, wherein:

FIG. 1A is a block diagram of an exemplary network in which a preferred embodiment of the present invention may be implemented;

FIG. 1B is a block diagram of exemplary contents of a memory as depicted in FIG. 1A according to a preferred embodiment of the present invention;

FIG. 2 is a high-level logical flowchart illustrating an exemplary method of intelligent window placement in digital video according to a preferred embodiment of the present invention; and

FIG. 3 is a high-level logical flowchart depicting a more detailed exemplary method of intelligent window placement in digital video taking into account the requested size of the window and the estimated duration of the display according to a preferred embodiment of the present invention.

### DETAILED DESCRIPTION OF A PREFERRED EMBODIMENT

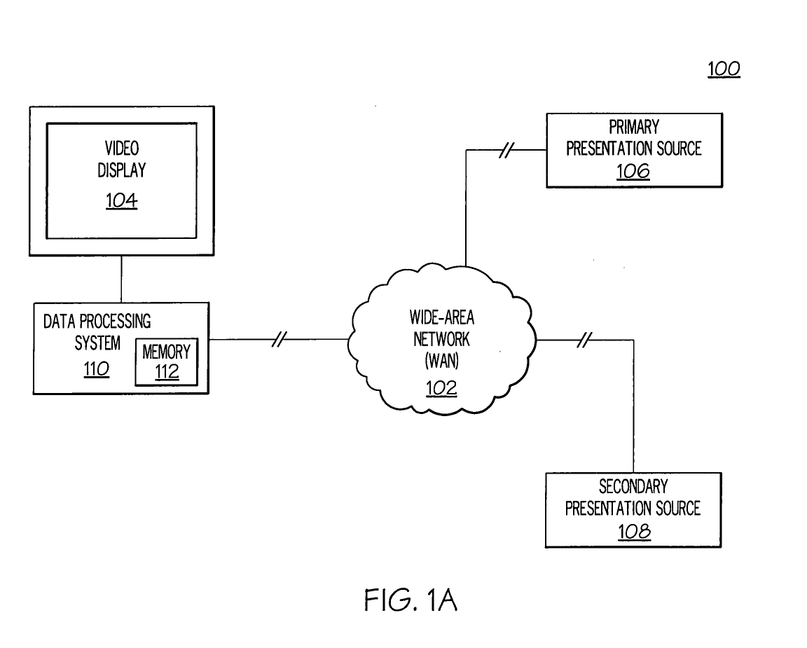

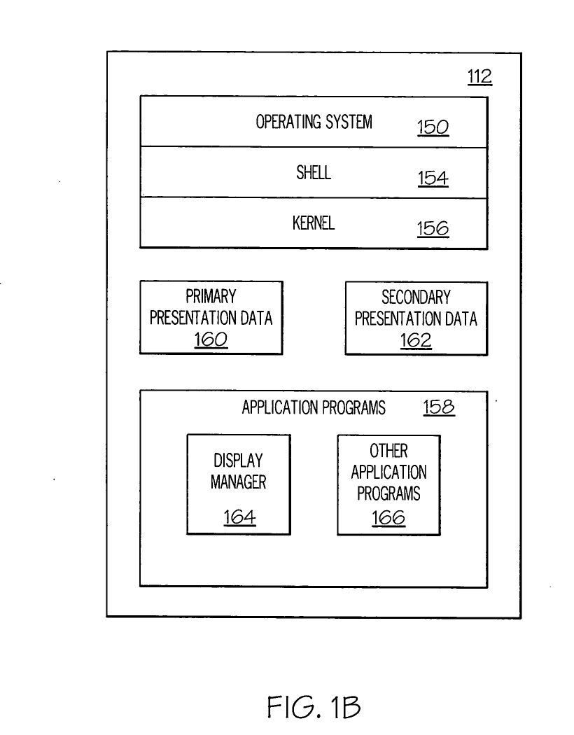

Referring now to the figures, and in particular, referring now to FIG. 1A, there is illustrated an exemplary network 100 in which a preferred embodiment of the present invention may be implemented. As depicted, network 100 includes a wide-area network (WAN) 102, video display 104, data processing system 110, primary presentation source 106, and secondary presentation source 108.

WAN 102 is preferably implemented as the Internet, but any network may be utilized to implement WAN 102. Video display 104 may be implemented as a cathode-ray tube (CRT), liquid crystal display (LCD), plasma, or any other type of video display.

Coupled to video display 104 is a data processing system 110, which may be implemented by any type of computer or programmable logic utilized to coordinate display of images on video display 104.

Data processing system 110 preferably includes a memory 112 for storing presentation data received from primary and secondary presentation sources. Primary presentation source 106 and secondary presentation source 108 may include, but are not limited to, television broadcast stations, Internet service provider servers, satellites, e-mail or instant message services, short message service (SMS) message services, Really Simple Syndication (RSS) feeds, or any other content provider that sends data to be displayed on video display 104. As depicted, data processing system 110, primary presentation source 106, and secondary presentation source 108 may be coupled to WAN 102 via Ethernet, wireless, telephone, or any other type of connection.

Those with skill in the art will appreciate that exemplary network 100 can include many additional components not specifically illustrated in FIG. 1A. Because such additional components are not necessary for an understanding of the present invention, they are not illustrated in FIG. 1A or discussed further herein.

With reference now to FIG. 1B, there is a block diagram illustrating exemplary contents of memory 112, as illustrated in FIG. 1A, according to a preferred embodiment of the present invention. As illustrated, memory 112 includes operating system 150, application programs 158, primary presentation data 160, and secondary presentation data 162.

Operating system 150 includes a shell 154 for providing transparent user access to resources such as application programs 158. Generally, shell 154 is a program that provides an interpreter and an interface between the user and the operating system. More specifically, shell 154 executes commands that are entered into a command line user interface or from a file. Thus, shell 154 (as it is called in UNIX®), also called a command processor in Windows@, is generally the highest level of the operating system software hierarchy and servers as a command interpreter. The shell provides a system prompt, interprets commands entered by keyboard, mouse, or other user input media, and sends the interpreted commands(s) to a appropriate lower levels of the operating system (e.g., a kernel 156) for processing. Note that while shell 154 is a text-based, line-oriented user interface, the present invention will equally well support other user interface modes, such as graphical, voice, gestural, etc.

As depicted, operating system 150 also includes kernel 156, which includes lower levels of functionality for operating system 150, including providing essential services required by other parts of operating system 150 and application programs 158, including memory management, process and task management, disk management, and mouse and keyboard management.

Application programs include display manager 164 and other application programs 166. Other application programs 166 may include, but are not limited to, word processors, web browsers, spreadsheets, etc.

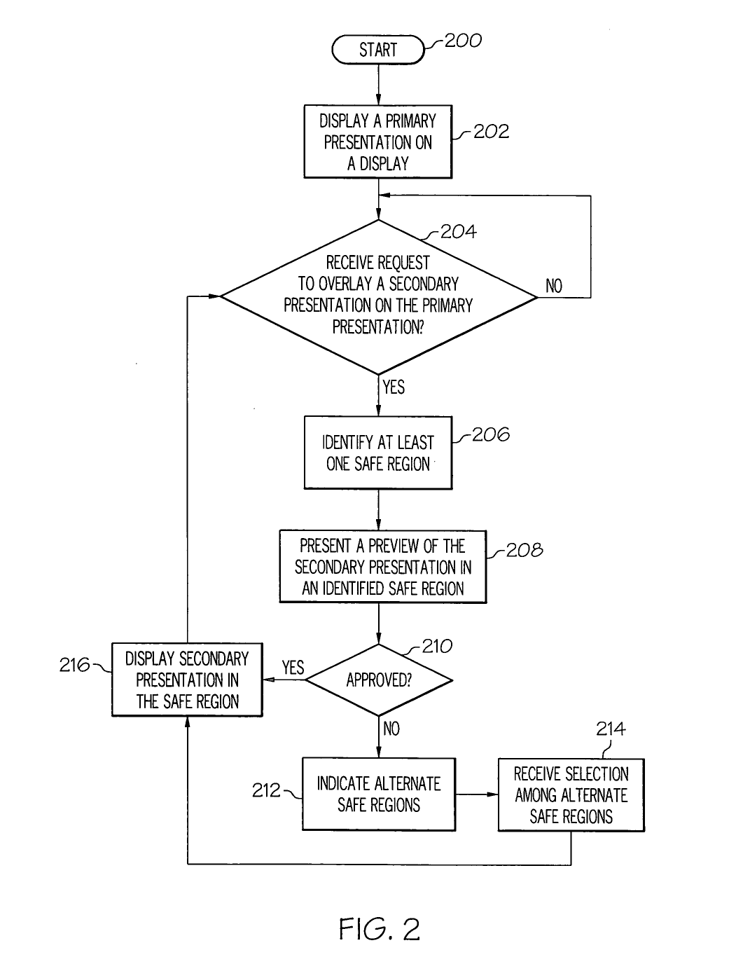

Display manager 164 displays primary presentation data 160 and secondary presentation data 162 on video display 104 and determines the location of the window that displays secondary presentation data 162. As discussed herein in more detail in conjunction with FIG. 2, display manager 164 determines if a request to overlay a secondary presentation on the primary presentation has been received, identifies at least one safe region, presents a preview of the secondary presentation in the identified safe region, and if the location of the identified safe region is approved, the secondary presentation will be displayed in the safe region.

A “safe region”, defined herein as a region that enables the display of a secondary presentation with minimal disruption of the primary presentation. Display manager 164 determines the safe regions within video display 104 by analyzing the primary presentation utilizing three factors: historical analysis, predictive analysis, and user input.

Historical Analysis:

Display manager 164 will analyze past (e.g., already displayed) frames of the primary presentation for clues to determine which regions will be considered “safe regions”. A composite record of all the “safe” and “unsafe” regions is made based on the last N frames of primary presentation displayed in video display 104. The “safe” and “unsafe” regions are preferably determined according to a set of criteria:

(1) frame-to-frame movement: Still-frame analysis of successive frames may indicate whether regions within the display contains “movement”, or the translation of a predefined number of pixels between successive frames. The still-frame analysis may include “motion tracking” to determine whether a designated “primary object” (e.g., a designated collection of pixels) is “moving spatially” (or translating between successive frames) to help determine future safe regions;

(2) screen location: Since most of the movement or action occurs n the center of video display 104, the regions at the edges of a presentation (where there is generally less movement or action) may be considered candidates for “safe regions”;

(3) color contrast: Important regions within a presentation are generally marked by high color contrast. Low contrast regions may be considered candidates for “safe regions”;

(4) repetitive motion: Any regions including repetitive, non-translating images (e.g., network logos and animated badges) may be considered candidates for “safe regions”;

(5) focus and detail: Regions of presentations which are out of focus may be considered candidates for “safe regions”;

(6) text: Regions of presentations containing text may be considered candidates for “unsafe regions”.

Predictive Analysis:

The dynamic nature of presentations may require that systems such as data processing system 110 anticipate the classification of the regions in future frames. For some pre-recorded presentations (e.g., digital video recorders (DVR), DVD, streaming video, etc.), it may be possible for display manger 162 to determine what regions are considered “safe” or “unsafe”, while utilizing the previously discussed set of criteria addressed in the “historical analysis” section.

User Input:

When the safe regions of video display 104 have been identified, display manager 164 may indicate to the viewer of video display 104 that a secondary presentation has been requested. Display manager 164 may sound an audible cue, mark a selected safe region with a visual marker, or slowly fade in a translucent presentation from secondary presentation source. If display manager 164 has designated as a safe region a region that is undesirable to the user, the user will be given a brief time interval in which to reject the selected safe region or relocate the secondary presentation utilizing a control device (e.g., mouse, keyboard, remote control, etc.) before the secondary presentation obstructs the view of important information in the primary presentation. The relocation of the secondary presentation may be accomplished by selecting a new safe region from a pre-defined set of alternate safe regions, utilizing a “second guess” function in which display manager 164 automatically selects an alternate safe region, or allowing the user to indicate a preferred safe regions by “drawing” a box of customizable size and position utilizing a control device.

In another preferred embodiment of the present invention, if the user rejects the selected safe region, display manager 164 can display on video display 104 a certain number of alternate regions and allow the user to toggle via the control device to the region the user would like to overlay the secondary presentation.

In still another preferred embodiment of the present invention, if a user repeatedly rejects a region designated by display manager 164 as a safe region, display manager 164 can store this rejection and utilize this information as criteria in the selection of future safe regions.

In still another preferred embodiment of the present invention, display manager 164 may moderately move or adjust the secondary presentation location remain in an area of least interest. Display manager 164 may move the secondary presentation slightly to accommodate the primary presentation according to the abovementioned criteria recited in the “historical analysis” section.

In still another preferred embodiment of the present invention, display manager 164 may present to a user several options for displaying the secondary presentation that includes a set of predefined regions that are defined as the four corners of the display, a set of predefined regions that are defined to be regions around the perimeter of the display, and a set of predefined regions determined by historical analysis, predictive analysis, and user input. Display manager 164 may also allow the user to determine “exclusionary regions” which are defined as regions that display manager 164 may never display a secondary presentation (e.g., regions near the center of the display).

Referring now to FIG. 2, there is a logical flowchart illustrating an exemplary method of intelligent window placement for digital video according to a preferred embodiment of the present invention. Generally, as utilized herein, the term “presentation” includes, but is not limited to, video, image, text displays, or any other type of visual display of information.

As depicted, the process begins at step 200 and proceeds to step 202, which illustrates data processing system 110 receiving a primary presentation from primary presentation source 106 via WAN 102, and displaying the primary presentation on video display 104. The process continues to step 204, which depicts display manager 164 determining whether a request to overlay a secondary presentation on the primary presentation has been received. If a request has not been received, the process iterates at step 204.

If a request has been received, the process continues to step 206, which illustrates display manager 164 identifying at least one safe region as a candidate region for displaying the requested secondary presentation. The process proceeds to step 208, which depicts display manager 164 presenting a preview of the secondary presentation in an identified safe region. As previously discussed, display manager 164 selects a region to be identified as a safe region utilizing three criteria: historical analysis, predictive analysis, and user input.

If a user has approved the location of the preview (step 210), display manager 164 displays the secondary presentation in the designated safe region (step 216). The process then returns to step 204 and continues in an iterative fashion.

If the user has not approved of the location of the preview (step 210), display manager 164 will indicate a selection of alternate safe regions in which the secondary presentation may be displayed (step 212). The alternate safe regions can be calculated in the same manner as the originally designated safe region. The user will selected an alternate safe region (step 214) and the process proceeds to abovementioned step 216, which depicts the secondary presentation being displayed in the selected safe region. The process returns to step 204 and proceeds in an iterative fashion.

In another preferred embodiment of the present invention, display manager 164 may enable a user to manually remove the secondary presentation after it is displayed via a control device (e.g., keyboard, mouse, etc.). The user may enter a set of user preferences or user profile that enables a secondary presentation to be removed by display manager 164 after a predetermined amount of time.

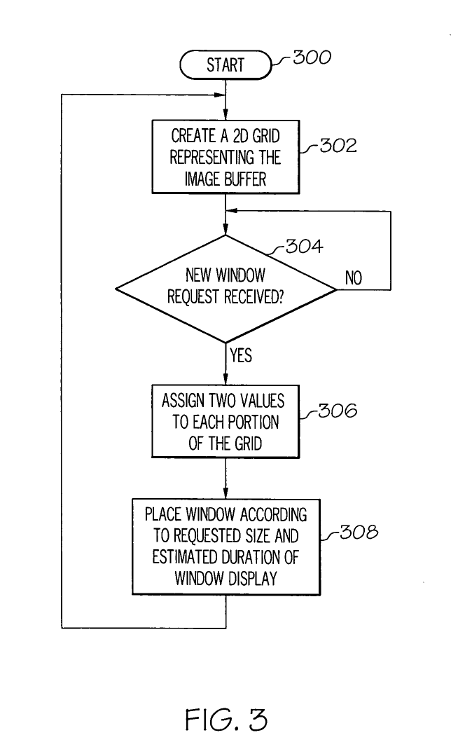

FIG. 3 is a high-level logical flowchart diagram depicting a more detailed exemplary method of intelligent window placement in digital video taking into account the requested size of the window and the estimated duration of the display according to a preferred embodiment of the present invention. In another embodiment of the presentation, display manager 164 may also take into account the size of the requested window for the display of the secondary presentation and the time required for the display in the determination of safe regions.

The process begins at step 300 and proceeds to step 302, which illustrates display manager 164 creating a two-dimensional grid in memory 112. The each square in the two-dimensional grid represents a region of video display 104. The process proceeds to step 304, which depicts a determination of whether display manager 164 has received a new window request to display a secondary presentation. If a new window request has not been received by display manager 164, the process iterates at step 304. If a new window request has been received by display manager 164, the process continues to step 306, which depicts display manager 164 assigning two values to each square in the two-dimensional grid. The values assigned depend on (1) how safe the region is determined by the abovementioned criteria under the “historical analysis” section; and (2) the length of time that region is determined to be safe. The process continues to step 308, which illustrates display manager 164 placing a window for display of the secondary presentation according to a variety of factors including, but not limited to, an estimate of how long that window will exist based on the type of window, previous interactions with that type of window, the content within that window (e.g., links messages, etc.), and other criteria. For example, a web browser window display a secondary presentation will likely require a longer duration than a simple message prompt. The process returns to step 302 and continues in an iterative fashion.

Those with skill in the art will appreciate that the present invention is not limited to the display of a secondary presentations over a primary presentation, but includes any number of presentations to be overlaid the primary presentation.

Those with skill in this art will appreciate that the present invention applies to both single-threaded and multi-threaded situations (i.e., where one process could handle incoming secondary presentation requests, such as identifying safe regions, while another thread is responsible for the displays themselves).

As discussed, the present invention includes, but is not limited to, a method, apparatus, and computer-usable medium for displaying a primary presentation on a display, where the primary presentation includes a collection of frames; in response to receiving a request to overlay the primary presentation with a secondary presentation, analyzing the plurality of frames to identify at least one safe region determined to be suitable for overlaying said primary presentation with a secondary presentation; presenting a preview of the secondary presentation in at least one safe region; in response to receiving a rejection of the preview, indicating a collection of alternate safe regions for presenting the secondary presentation; and in response to an alternate safe region among the collection of alternate safe regions being selected, displaying the secondary presentation in the selected alternate safe region.

It should be understood that at least some aspects of the present invention may be alternatively be implemented in a computer-usable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to Random Access Memory (RAM), and communication media, such as computer and telephone networks, including Ethernet, the Internet, wireless networks, and like network systems. It should be understood, therefore, that such signal-bearing media when carrying or encoding computer-readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A method comprising:
displaying a primary presentation on a display, wherein said primary presentation includes a plurality of frames;
in response to receiving a request to overlay said primary presentation with a secondary presentation, analyzing said plurality of frames to identify at least one safe region determined to be suitable for overlaying said primary presentation with said secondary presentation;
presenting a preview of said secondary presentation in said at least one safe region;
in response to receiving a rejection of said preview, indicating a plurality of alternate safe regions for presenting said secondary presentation; and
in response to an alternate safe region among said plurality of alternate safe regions being selected, displaying said secondary presentation in said selected alternate safe region.

2. The method according to claim 1, wherein said analyzing said plurality of frames to identify at least one safe region further comprises:
dividing said display into a plurality of regions;
assessing said plurality of regions utilizing a plurality of criteria, wherein said plurality of criteria includes:
designating at least one collection of pixels within one region among said plurality of regions to be assessed;
determining whether said at least one collection of pixels with said one region undergoes a translation;
measuring color contrast of said plurality of regions;
analyzing focus and detail of said plurality of regions;
indicating border regions among said plurality of regions as candidates for safe regions; and
in response to determining at least one region among said plurality of regions includes text, designating said at least one region as a candidate for an unsafe region.

3. The method according to claim 1, wherein said presenting a preview of said secondary presentation in said at least one safe region further comprises:
sounding an audible cue; and
marking said at least one safe region with a visual marker.

4. The method according to claim 1, wherein said presenting a preview of said secondary presentation in said at least one safe region further comprises:
fading in a translucent secondary presentation in said at least one safe region.

5. The method according to claim 1, further comprising:
enabling user-defined removal of said secondary presentation.

6. A system comprising:
a video display;
a data processing system coupled to said video display;
a computer-usable medium embodying computer program code, said computer-usable medium coupled to said data processing system, said computer program code comprising instructions processed by said data processing system and configured for:
displaying a primary presentation on a display, wherein said primary presentation includes a plurality of frames;
in response to receiving a request to overlay said primary presentation with a secondary presentation, analyzing said plurality of frames to identify at least one safe region determined to be suitable for overlaying said primary presentation with said secondary presentation;
presenting a preview of said secondary presentation in said at least one safe region;
in response to receiving a rejection of said preview, indicating a plurality of alternate safe regions for presenting said secondary presentation; and
in response to an alternate safe region among said plurality of alternate safe regions being selected, displaying said secondary presentation in said selected alternate safe region.

7. The system according to claim 6, wherein said instructions for analyzing said plurality of frames to identify at least one safe region further comprises instructions configured for:
dividing said display into a plurality of regions;
assessing said plurality of regions utilizing a plurality of criteria, wherein said plurality of criteria includes:
designating at least one collection of pixels within one region among said plurality of regions to be assessed;
determining whether said at least one collection of pixels with said one region undergoes a translation;
measuring color contrast of said plurality of regions;
analyzing focus and detail of said plurality of regions;
indicating border regions among said plurality of regions as candidates for safe regions; and
in response to determining at least one region among said plurality of regions includes text, designating said at least one region as a candidate for an unsafe region.

8. The system according to claim 6, wherein said instructions for presenting a preview of said secondary presentation in said at least one safe region further comprises instructions configured for:
sounding an audible cue; and
marking said at least one safe region with a visual marker.

9. The system according to claim 6, wherein said instructions for presenting a preview of said secondary presentation in said at least one safe region further comprises instructions configured for:
fading in a translucent secondary presentation in said at least one safe region.

10. The system according to claim 6, wherein said instructions are further configured for:
enabling user-defined removal of said secondary presentation.

11. A computer-usable medium embodying computer program code, said computer program code comprising computer executable instructions configured for:
displaying a primary presentation on a display, wherein said primary presentation includes a plurality of frames;
in response to receiving a request to overlay said primary presentation with a secondary presentation, analyzing said plurality of frames to identify at least one safe region determined to be suitable for overlaying said primary presentation with said secondary presentation;
presenting a preview of said secondary presentation in said at least one safe region;
in response to receiving a rejection of said preview, indicating a plurality of alternate safe regions for presenting said secondary presentation; and
in response to an alternate safe region among said plurality of alternate safe regions being selected, displaying said secondary presentation in said selected alternate safe region.

12. The computer-usable medium according to claim 11, wherein said instructions for analyzing said plurality of frames to identify at least one safe region further comprises computer executable instructions configured for:
dividing said display into a plurality of regions;
assessing said plurality of regions utilizing a plurality of criteria, wherein said plurality of criteria includes:
designating at least one collection of pixels within one region among said plurality of regions to be assessed;
determining whether said at least one collection of pixels with said one region undergoes a translation;
measuring color contrast of said plurality of regions;
analyzing focus and detail of said plurality of regions;
indicating border regions among said plurality of regions as candidates for safe regions; and
in response to determining at least one region among said plurality of regions includes text, designating said at least one region as a candidate for an unsafe region.

13. The computer-usable medium according to claim 11, wherein said instructions for presenting a preview of said secondary presentation in said at least one safe region further comprises computer executable instructions configured for:
sounding an audible cue; and
marking said at least one safe region with a visual marker.

14. The computer-usable medium according to claim 11, wherein said instructions for presenting a preview of said secondary presentation in said at least one safe region further comprises computer executable instructions configured for:
fading in a translucent secondary presentation in said at least one safe region.

15. The computer-usable medium according to claim 11, wherein said computer executable instructions are further configured for:
enabling user-defined removal of said secondary presentation.
